(19) United States
(12) Patent Application Publication
(10) Pub. No.: US 2013/0166354 A1
(43) Pub. Date: Jun. 27, 2013

(54) VALUATION ESTIMATION

(71) Applicants: Patrick Hummel, Berkeley, CA (US); Tom Gulik, Santa Clara, CA (US); Michael Schwarz, Berkeley, CA (US); Sergey Smirnov, Campbell, CA (US)

(72) Inventors: Patrick Hummel, Berkeley, CA (US); Tom Gulik, Santa Clara, CA (US); Michael Schwarz, Berkeley, CA (US); Sergey Smirnov, Campbell, CA (US)

(73) Assignee: Yahoo! Inc., Sunnyvale, CA (US)

(21) Appl. No.: 13/335,653

(22) Filed: Dec. 22, 2011

(51) Int. Cl. G06Q 30/02

(52) U.S. Cl. 705/7.35

(57) ABSTRACT

Example systems, methods, apparatuses, or articles of manufacture, etc. are disclosed that may collect, process, or use estimates of market value.

### BACKGROUND

1. Field

This disclosure relates to obtaining, ranking, or aggregating estimates of value.

2. Information

The rate at which content is created continues to increase. A large amount of content may be made available via the Internet. The Internet itself is widespread and may provide access to the “World Wide Web” (WWW), also referred to as the web. The web, as merely an example, may operate as a destination, a source, or a repository of content. Content, such as, for example, web pages, text, images, audio, video, or combinations thereof, etc. may be continually identified, located, retrieved, accumulated, stored, communicated, or otherwise manipulated, such as via the Internet. As a result, the Internet has become a common tool to accumulate or share content. Likewise, dissemination of content from one entity to many entities may be facilitated via the web.

Unfortunately, the amount and wide dissemination of content may make it more challenging to identify more useful content from less useful content. Consequently, there is an ongoing need for procedures or arrangements that may enable content to be collected and/or disseminated in more useful ways.

### BRIEF DESCRIPTION OF DRAWINGS

Non-limiting and/or non-exhaustive aspects are described with reference to the following figures, wherein like reference numerals refer to like parts throughout the various figures, unless otherwise specified.

FIG. 1 is a schematic diagram illustrating an example embodiment.

FIG. 2 is a schematic diagram illustrating an example embodiment.

FIG. 3 is a schematic diagram illustrating an example embodiment.

FIG. 4 is a schematic diagram of an example computing environment according to an embodiment.

FIG. 5 is a schematic diagram illustrating an example embodiment.

FIG. 6 is a flow diagram that illustrates an example method according to an embodiment.

FIG. 7 is a flow diagram that illustrates an example method according to an embodiment.

FIG. 8 is a schematic diagram of example devices according to an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, systems, or technologies that generally would be known by a person of ordinary skill in the relevant art have not been described in detail so as not to obscure claimed subject matter.

Services or capabilities of the Internet may be designed or employed to collect or disseminate content. For example, web sites or services may enable one to transfer content to those interested in acquiring it. For example, web pages, blog entries, comments, emails, or combinations thereof, etc. are capable of being created and/or likewise accessed by others. Content may be accessible via the Internet via any of a number of different mechanisms. By way of example only, one may subscribe to really simple syndication (RSS) streams, join social networks, or use search engines. However, mechanisms are not generally available so that available content may generally be sufficiently exploited, especially given the volume available and few approaches for identifying more useful content.

For example, the Internet may comprise a source of market estimates of value for a variety of objects or items that may be for sale. However, it may be challenging to assess which estimates are more accurate. As one example, without limit, a piece of real estate may be available for sale. Likewise, content related to the real estate, including photos, offering price, etc., may also be readily available. In addition, a number of possible sources for an estimate of value for the real estate may also be accessible. However, it may be quite challenging to determine which, if any, value estimates are more likely to be accurate. Typically, estimates of market value may originate from multiple sources.

In one embodiment of claimed subject matter, one or more sources for market value estimates may be ranked for accuracy. For example in an embodiment, one or more sources of estimates of market value of one or more unique identifiable objects, such as a piece of real estate as a non-limiting example, may be used, for example, to generate one or more indications or measures of accuracy. Measurements of accuracy of sources of estimates of market value may be generated by employing transaction values that correspond to the one or more unique identifiable objects, for example. However, claimed subject matter is not limited to these specific embodiments.

As used herein, the term unique object or unique identifiable object refers to an item, a thing, or article, etc. that is unique. Unique items or objects may provide challenges in terms of valuation, such as providing an estimate of market value, because information from sales of other objects or items are not necessarily reliable since those items are different in some particular, often several, aspects. Example types of identifiable objects may include, but are not limited to, personal property, real property, intellectual property, or any combinations thereof, etc. Likewise, type may also refer to subgroupings of types of objects. For example, real estimate in a geographical region may comprise a type of object. Examples of unique identifiable objects may include, but are not limited to: a work of art, such as a painting, or a sculpture, etc.; a parcel of real estate, such as land, a home, a house, a duplex, an apartment, an apartment building, or a commercial structure, etc.; a financial asset, such as a stock, or a unit of commodities, etc.; a collectible, such as a comic book, a car, or a stamp, etc.; or any combination thereof; etc. However, claimed subject matter is not limited to these specific examples of unique identifiable objects.

As used herein, the term estimate of market value refers to a valuation of worth or merit, typically provided in monetary or other financial terms. Estimate refers to a prediction or forecast of a value that is expected to be exchanged for an object in a sale transaction or other similar transfer. A sale or other similar transfer may occur, for example, between a willing seller and a willing buyer in a market typically resembling a free market or in another reasonably similar market environment. As used herein, the term transaction value refers to a worth or merit, typically provided in monetary or other financial terms, exchanged for a unique object in a sale or other similar transfer. As used herein, the term source refers to a source of an estimate of market value. A source may include, for example: an individual, a group, an entity, a device, or any combination thereof, etc. Additional examples of sources are described herein below. Of course, claimed subject matter is not limited to these specific examples.

As alluded to previously, sources of market value estimates may be ranked for accuracy in an embodiment. For example, in an embodiment, a ranking of multiple sources may be generated based, at least in part, on accuracy of estimates of market value relative to transaction value, such as for previously executed transactions. Although claimed subject matter is not limited in scope in this respect, as an example, ranking of multiple sources may be provided to visitors of, for example, a web site.

Sources may be ranked, for example, based at least partly on accuracy of one or more previous estimates. In certain example implementations, unique objects may comprise parcels of real estate. As an example, without limitation, real estate agents or real estate appraisers may be given an opportunity to provide estimates of sale prices for real estate available for sale. Thus, estimates made by various real estate professionals may be collected and compared with transaction value.

For example, although claimed subject matter is not limited in scope in this respect, incentives may be provided, such as for real estate agents or other similar professionals, to participate in a process of predicting or estimating market value. For example, a competition may be conducted to provide an accurate prediction or estimate for a particular unique object. This may thereby encourage participation due at least in part to its competitive nature or entertainment value, for example. Additionally or alternatively, a form of advertising, marketing, publicity, or any combination thereof, etc. may likewise be offered. For example, real estate agents that participate may be ranked, at least in part, based on accuracy of their predictions. Publication of this ranking may be perceived as valuable to potential participants.

For example, a ranking may be publicized by way of a web page, an email, an installable application, or any combination thereof, etc. For instance, a number of more highly ranked real estate agents may be announced on one or more web pages covering real estate topics to thereby provide free or un-paid-for publicity that may aid their respective businesses or careers, for example. Claimed subject matter is not, however, limited to these particular examples.

For an embodiment, to provide a ranking, a process for normalization across sources and/or objects for which estimates have been made may be desirable. A variety of approaches is possible and is intended to be included in the scope of claimed subject matter. As alluded to previously, challenges exist at least partially due to the uniqueness of the objects or items. However, in one example approach, normalizing across sources may be desirable, such as for a given unique object, for example, so that accuracy of estimates may be compared.

For example, continuing again with a parcel of real estate as an example, sources may submit estimates of market value. After a sale has taken place, estimates may be ranked for accuracy. Therefore, a source providing the closest estimate of market value, that is, closest to transaction value out of provided estimates, may be assigned a largest number of ‘points,’ where the number of points, for example, may exceed the number of sources in any given competition. For example, if there are 10 sources, the source closest to the transaction value may be assigned 1000 points. Likewise, a source providing a second most accurate estimate, e.g., second closest to transaction value, may be assigned a second largest number of points, here 999 points.

To compare across multiple objects, point values may be combined. Points a source has been assigned across multiple competitions may be computed to determine an accuracy score for estimates of market value. Accuracy scores assigned may be used to generate an accuracy ranking by giving relatively higher rankings to relatively higher point scores. Likewise, in alternate embodiments, points may be normalized before being combined in a variety of ways. For example, to avoid overweighing a source that has participated in more competitions, score values may be averaged before ranking.

In yet another example embodiment, in a given competition, if k sources provide an estimate, k−1 accuracy points may be assigned to a most accurate estimate of market value, or k−3 points may be assigned to a second most accurate estimate of market value. More generally, k+1−2 m points may be assigned to an mth most accurate estimate of market value. Scores assigned may be used to generate a ranking again by giving relatively higher rankings to relatively higher point scores. A potential benefit here may be assignment of negative points to reduce a risk of overweighing as a result of participation in many competitions, for example. Likewise, in alternate embodiments, again, score values may be averaged before ranking.

For yet another example embodiment, if sources provide an estimate, a certain number of accuracy points may be transferred between sources providing estimates. A number of points to transfer may be determined using a difference, such as absolute value, between a transaction value and an estimate. Thus, for example, a source may receive points from other sources and provide (e.g, lose) points to other sources. As a result, a source with the greatest number of accuracy points in a competition to value a unique object provided the closest estimate.

One illustrative embodiment implementing the approach just described is provided, although, again, claimed subject matter is not limited in scope to illustrative embodiments. Consider, for example, two sources, A and B, which have estimated the value of a unique object. Let R_A denote the total number of points source A had earned before this estimate and let R_B denote the total number of points source B had earned before this estimate from previous estimates. In an example embodiment, one may compute Q_A=10̂(R_A/400) (where x̂ y denotes x raised to the y power), Q_B=10̂(R_B/400), and E=Q_A/(Q_A+Q_B). In this embodiment, E provides a weighted average measure to reflect accuracy of A relative to B for past estimates, for example. Therefore, E may, in effect, roughly at least provide a probabilistic measure of A providing a more accurate estimate than B.

Therefore, for this example embodiment, if A makes a more accurate estimate than B, then A obtains an additional K(1−E)/sqrt(n−1) points, where K is some constant that may be employed so that values are more convenient, for example, aggregated across a variety of estimates, and sqrt(x) denotes the square root of x. B loses an identical number of points to reflect a transfer from B to A. If B make a more accurate estimate than A, then B obtains an additional K*E/sqrt(n−1) points and A loses an identical number of points to offset the gain to B. If both A and B make equally accurate estimates, then A obtains an additional K(1/2−E)/sqrt(n−1) points, and B loses the same number of points, again to offset the gain by A. A similar calculation for pairs of sources taken two at a time out of n that estimated the value of the object may be performed. For example, for n sources, A may be compared with the other sources, n−1, to compute the number of points source A obtains after making an estimate if n sources estimate the value of the object. Likewise, similar calculations may be performed for the remaining n−1 sources to compute the number of points gained or lost as a result.

An example embodiment employing an approach such as above may have several benefits. For example, a number of points a source may obtain for making a more accurate estimate than another source depends at least partially on the number of points received previously. A source obtains more points for making a more accurate estimate than a source who has previously earned a lot of points in comparison with making a more accurate estimate than a source who has previously earned a fee points. Thus, there is a greater reward for making more accurate estimates than sources that have been accurate historically than there is for making more accurate estimates than sources that have been inaccurate historically or than sources that have not made a lot of estimates. In addition, a number of points a source obtains from making a more accurate estimate than another source depends at least partially on the number of other sources that are making an estimate. In this example embodiment, if a source makes the most accurate estimate of a large number of sources, the source will earn more points than if the source made the most accurate estimate of a small number of sources. But the number of additional points a source earns by making the most accurate estimate of a large number of sources is mitigated in such a way that one lucky estimate will not suddenly earn the source some undeservedly large number of points.

Thus, for an example embodiment, as indicated, a ranking of sources may be generated. Sources with the better accuracy ranking historically may be assumed to provide more accurate estimates of market value in the future. For example, a ranking, as described, may be provided via a web site or via some other approach, as previously described.

In another embodiment, appraisals may be created based at least in part on an aggregation of estimates of market value. In an example embodiment, a metric reflecting a measure of accuracy of estimates may be assessed, such as by ascertaining a source's estimates of market value compared to transaction values in the past. For example, accuracy ranking, such as previously described, may be employed in an embodiment. In another embodiment, additional characteristics of a source may also be used.

For example, in an embodiment, one or more appraisals may be created by combining multiple estimates of market value provided by multiple sources using any one or more of a number of different processes. Example estimate combining processes may include, but are not limited to, computing a weighted median or a weighted mean of provided estimates adjusted to reflect uncertainty. For example, weights may be assigned as a function of one or more metrics such as measurements that may reflect historical accuracy of estimates or other measurements to capture uncertainty.

In certain example embodiments, appraisals based, at least in part, on an aggregation of estimates of market value may be sold. In an example embodiment, estimates of market value may be used to generate one or more appraisals. Generated appraisals may be sold, such as via the web. Likewise, although claimed subject matter is not limited in scope to the web, and unrelated to the sale of appraisals via the web, the ubiquitous nature of the web and the possibility of participation in a public competition may provide a reasonably strong incentive so that sources may be more incentivized as a result to provide accurate estimates of market value by giving rewards, such as highly visible placement in a ranking or other rewards, for predicting a transaction value accurately.

An appraisal may be sold to entities that wish to obtain an accurate estimate of a value of an object or item, such as for a parcel of real estate, continuing with that example. For example, in an embodiment, an appraised value for a particular unique identifiable object may be generated, such as previously described. An appraised value for a particular unique identifiable object may likewise be marketed or sold via a computing platform, such as via a server on the Internet, as an example. However, claimed subject matter is not limited to generating an appraised value for a particular identifiable unique object.

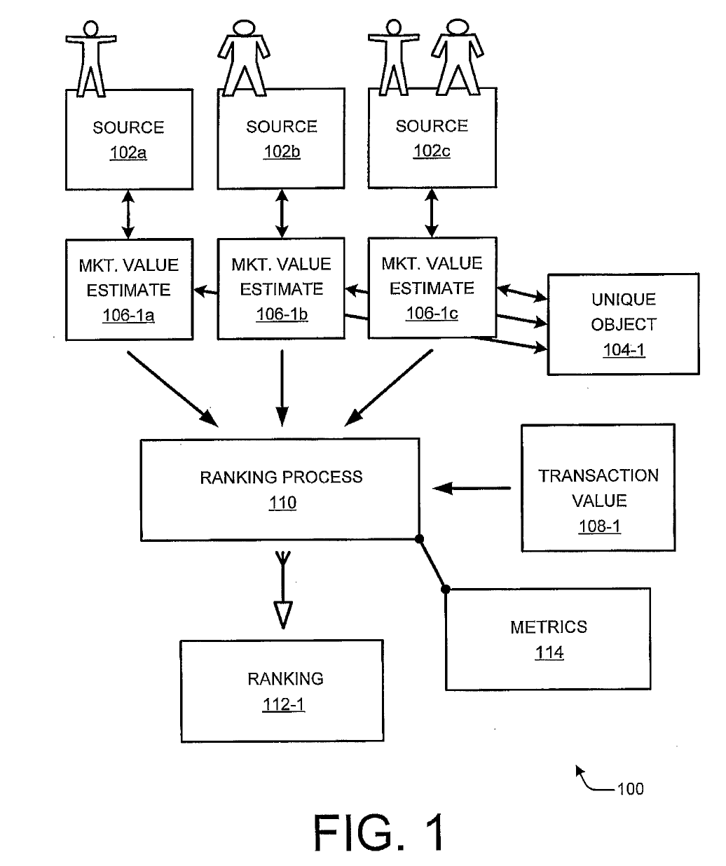

FIG. 1 is a schematic diagram illustrating an example embodiment 100. More specifically, three sources 102a, 102b, or 102c may provide estimates of market value for a unique object. Again, as an example, a parcel of real estate, such as unique object 104-1, may be the object to be valued. Three market value estimates 106-1a, 106-1b, or 106-1c may therefore be provided from respective sources. A source, as used herein, may comprise an example of a source of an estimate of market value. A source may include, by way of example but not limitation, an individual, a group, an entity, a layperson, an expert, or any combination thereof, etc, as previously described.

Therefore, sources 102a, 102b, or 102c in this illustrative example may respectively provide or otherwise be associated with market value estimates 106-1a, 106-1b, or 106-1c. Market value estimates 106-1a, 106-1b, or 106-1c may correspond to object 104-1. Market value estimates 106-1a, 106-1b, or 106-1c may indicate predictions or forecasts as to what respective sources 102a, 102b, or 102c expect a transaction value to be for identifiable object 104-1.

In an example embodiment, a ranking process 110 may be conducted. For example, metrics to reflect market estimate accuracy, for example, may be computed and employed to produce an accuracy ranking. Transaction value 108-1 may correspond to object 104-1. For example, transaction value 108-1 may indicate a value exchanged for object 104-1 in a sale or similar transaction.

Metrics 114 may comprise a computed metric to measure accuracy of market value estimates, such as 106-1a, 106-1b, or 106-1c. By way of example only, an indication or measure of accuracy may be determined based, at least in part, on a comparison including a market value estimate, such as 103, and an transaction value, such as 108-1. For instance, an indication of accuracy may be determined based, at least in part, on a difference between a market value estimate and a transaction value 108-1. Metrics 114 may be employed by a ranking process, such as 110. Likewise, a ranking process may compute metrics or metric values may be provided. However, claimed subject matter is not limited to any particular approach to computing a metric. A variety of approaches are possible. In an example embodiment, ranking process 110 may generate ranking 112-1 based, at least in part, on one or more metrics 114. For example, ranking 112-1 may be based, at least in part, on relative sizes of differences between transaction value 108-1 and market value estimates 106-1a, 106-1b, or 106-1c of object 104-1. Likewise, a variety of approaches to ranking are possible, such as examples described earlier. Again, claimed subject matter is not limited to a particular illustrative approach.

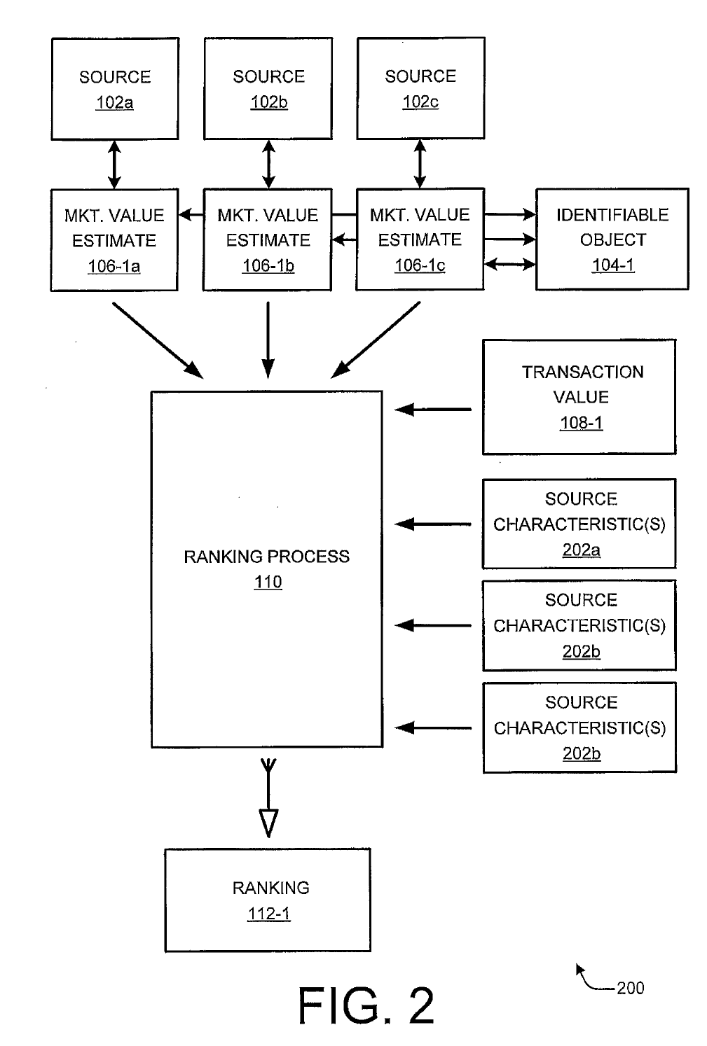

FIG. 2 is a schematic diagram illustrating an example embodiment 200. Embodiment 200 is similar in some respects to embodiment 100. However, for this example embodiment, source characteristics 202a, 202b, or 202c may be respectively associated with sources 102a, 102b, or 102c. Examples of characteristics 202 may include, but are not limited to, a duration of experience (e.g., in months or years), educational degrees, certifications, a number of executed transactions, a number of provided market value estimate, a placement in another ranking, any combination thereof, etc.

In an example embodiment, a characteristic 202 may be used by a ranking process, such as 110, to affect a ranking placement of a source in ranking 112-1. For example, a characteristic may be used to adjust a number of points that are assigned to a source. Points may be adjust, such as increased or decreased, by way of example, to points that otherwise were assigned. As one example, a given source, such as a given real estate agent, may be awarded additional points for having greater than ten years of experience as a real estate agent. As another example, a different real estate agent that has never participated in a real estate transaction may have points deducted. Point adjustments associated with characteristics may therefore affect a generated ranking.

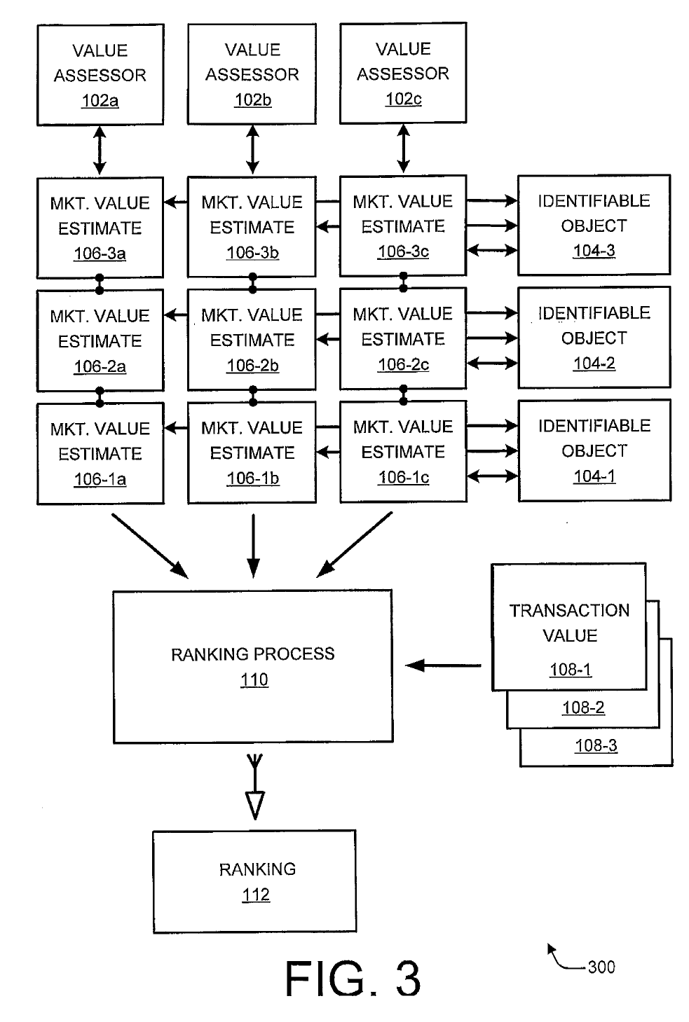

FIG. 3 is a schematic diagram illustrating an example embodiment 300. Again, embodiment 300 is similar in some respects to embodiments 100 and 200. However, additional unique objects are involved in this example, such as 104-2 and 104-3. Sources 102a, 102b, or 102c may respectively provide or otherwise be associated with market value estimates 106-1a, 106-2a, or 106-3a; 106-1b, 106-2b, or 106-3b; or 106-1c, 106-2c, or 106-3c. Market value estimates 106-1a, 106-1b, or 106-1c may correspond to identifiable object 104-1, as previously. Market value estimates 106-2a, 106-2b, or 106-2c may correspond to identifiable object 104-2. Market value estimates 106-3a, 106-3b, or 106-3c may correspond to identifiable object 104-3.

As before, market value estimates 106-1a, 106-1b, or 106-1c may indicate predictions or forecasts as to what respective sources 102a, 102b, or 102c expect a transaction value to be for identifiable object 104-1. Likewise, market value estimates 106-2a, 106-2b, or 106-2c may indicate predictions or forecasts as to what respective sources 102a, 102b, or 102c expect a transaction value to be for identifiable object 104-2. Market value estimates 106-3a, 106-3b, or 106-3c may indicate predictions or forecasts as to what respective sources 102a, 102b, or 102c expect a transaction value to be for identifiable object 104-3.

In an example embodiment, a ranking process, such as 110, may generate a ranking, such as 112, based, at least in part, on market value estimates 106 that correspond to multiple identifiable objects 104. For example, transaction value 108-1 may correspond to identifiable object 104-1, as before. Likewise transaction value 108-2 may correspond to identifiable object 104-2 and transaction value 108-3 may correspond to identifiable object 104-3. Therefore, as discussed previously, normalization both across sources and across objects may be desirable. For example, a variety of approaches to computing point metrics, as discussed previously, to measure accuracy, may be employed.

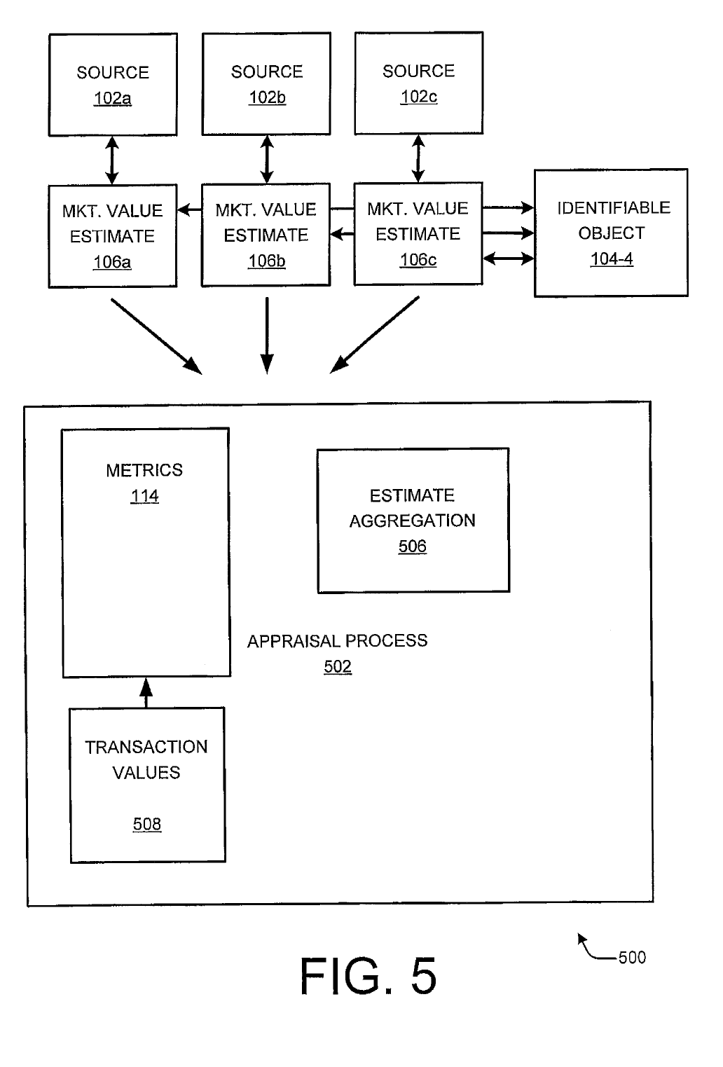

FIG. 5 is a schematic diagram illustrating an example embodiment. More specifically, this illustrative example employs three sources 102a, 102b, or 102c providing three market value estimates 106a, 106b, or 106c for unique object 104-4 as shown in FIG. 5. As before, market value estimates 106a, 106b, or 106c may indicate predictions or forecasts as to what respective sources 102a, 102b, or 102c expect a transaction value to be for particular identifiable object 104-4. In an example embodiment, an appraisal process, such as 502, may compute one or more metrics, such as 114; however, alternately, one or more metrics, such as 114, may be computed apart from an appraisal process, such as 502. Although not shown, an appraisal process, such as 502, may compute or otherwise obtain a ranking, such as 112 (e.g., of FIGS. 1-3).

Metrics 114 may provide a measure of accuracy of sources 102a, 102b, or 102c, as previously described, for example. By way of example only, an indication or measure of accuracy may be determined based, at least in part, on a comparison including one or more previous market value estimates (e.g., market value estimates 106-1a through 106-3a, 106-1b through 106-3b, or 106-1c through 106-3c of FIG. 3) and one or more corresponding transaction values (e.g., transaction value 108-1, 108-2, or 108-3 for identifiable objects 104-1, 104-2, or 104-3, respectively, of FIG. 3). For instance, a measure of accuracy may be determined based, at least in part, on differences between market value estimates and transaction value for previous transactions, as denoted by 508, for example. Metrics 114 may computed as part of an appraisal process or may be provided from e.g. market value estimates or transaction values of sources 102a, 102b, or 102c. However, claimed subject matter is not limited to any particular approach to computing metrics, such as 114.

In an example embodiment, an appraisal process, such as 502, may generate an appraised value, such as 504, based, at least in part, on (i) one or more metrics, such as 114, corresponding to sources, such as 102a, 102b, or 102c, and/or (ii) one or more market value estimates, such as 106a, 106b, or 106c, corresponding to a unique object, such as 104-4.

For example, estimate aggregation may be employed as part of an appraisal process. For example, market value estimates from sources may be collected and combined. For example, metrics providing a measurement of accuracy for various sources may be employed to adjust or discount an estimate to reflect an amount of associated uncertainty. In one example embodiment, a weighing process may be employed, although claimed subject matter is not limited in scope in this respect. A variety of approaches is known and may be used. For example, complex filtering may likewise be employed, such as time series analysis, Kalman filtering, analysis of variance or a host of other possible approaches may be employed in connection with estimate aggregation. In one example embodiment, estimate aggregation may comprise weighing respective ones of market value estimates 106a, 106b, or 106c based, at least in part, on metrics, such as 114, that are associated with respective ones of sources 102a, 102b, or 102c to determine a weighted mean or median of market value estimates 106. If, by way of example only, source 102b is associated with better consistent accuracy than source 102c, a market value estimate 106b may be weighed more heavily than market value a estimate 106c to generate appraised value 504. Additionally or alternatively, weighting of market value estimates 106a, 106b, or 106c may be based at least partially on a ranking, such as 112, for example. However, claimed subject matter is not limited to any particular illustrative example embodiment for generating an appraised value.

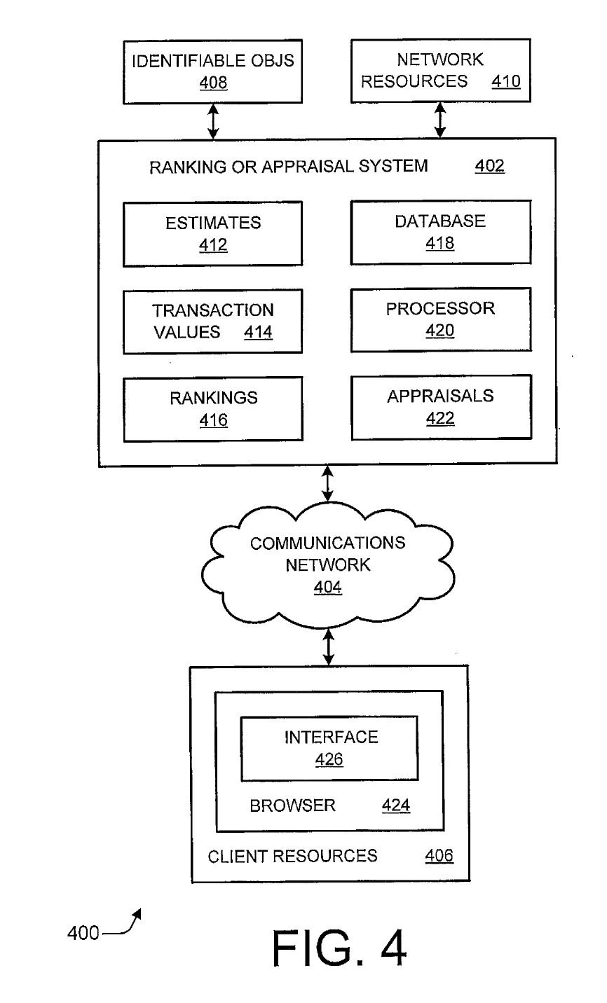

FIG. 4 is a schematic diagram of an example computing environment 400 in accordance with an embodiment. As illustrated, computing environment 400 may include ranking or appraisal system 402, one or more communication network(s) 404, one or more client resource(s) 406, and network resources 410. Ranking or appraisal system 402 may include or have access to estimates 412, transaction values 414, rankings 416, database 418, processor 420, appraisals 422, or any combination thereof, etc. Although ranking or appraisal system 402 is shown as including components 412-422, it alternatively may include more components or may omit components. Client resources 406, which may present a graphical user interface 426 which may include browser 424. Ranking or appraisal system 402 or client resources 406 may alternatively include more, fewer, or different components than those that are shown without departing from claimed subject matter.

In an example embodiment, estimates 412 may comprise a collection of market value estimates, such as 106 (e.g., of FIG. 1-3 or 5). Transaction values 414 may comprise a set of transaction values, such as 108 (e.g., of FIG. 1-3 or 5). Rankings 416 may comprise rankings, such as 112 (e.g., of FIGS. 1-3). Appraisals 422 may comprise one or more appraised values, such as 506 (e.g., of FIG. 5). Database 418 may store a variety of content in the form of physical memory states, such as, for example, estimates 412, transaction values 414, rankings 416, appraisals 422, or any combination thereof, etc. Database 418 may also store characteristics of, such as those that identify or describe identifiable objects 408. Processor 420 may execute instructions to use estimates 412 to generate rankings 416 or appraisals 422, as described, for example, with respect to a ranking process, such as 110 (e.g., of FIGS. 1-3) or with response to an appraisal process, such as 502 (e.g., of FIG. 5).

In an example embodiment, an appraisal system, such as 402, may be in communication with client resources, such as 406, via a communication network, such as 404. Communication network 404 may comprise one or more wireless or wired networks, or any combination thereof. Examples of communication networks 404 may include, but are not limited to, a Wi-Fi network, a Wi-MAX network, the Internet, the web, a local area network (LAN), a wide area network (WAN), a telephone network, or any combination thereof, etc.

As illustrated in FIG. 4, an appraisal system, such as 402, may be operatively coupled to network resources 410 or to communications network 404, for example. An end user, for example, may communicate with appraisal system, such as 402, via a communications network, such as 404, using, e.g., client resources, such as 406. For example, a user may wish to search for or otherwise access one or more web documents related to a category of objects.

For instance, for example, for real estate, a user may send a request relating to parcels of real estate. A request may be transmitted using client resources, such as 406, as signals via a communications network, such as 404. Client resources, for example, may comprise a personal computer or other portable device (e.g., a laptop, a desktop, a netbook, a tablet or slate computer, etc.), a personal digital assistant (PDA), a so-called smart phone with access to the Internet, a gaming machine (e.g., a console, a hand-held, etc.), a mobile communication device, an entertainment appliance (e.g., a television, a set-top box, an e-book reader, etc.), or any combination thereof, etc., just to name a few examples.

A system, such as 402, may receive, via a communications network, such as 404, signals representing a request that relates to a category of objects that includes a unique object, for example. System 402 may initiate transmission of signals to provide a ranking of multiple sources or to provide an appraisal based at least in part on market estimates from multiple sources, for example. Thus, for example, publicity to sources that provide estimates of market value may be created, for example. However, claimed subject matter is not limited to providing publicity to sources, of course.

Client resources, such as 406, may include a browse, such as 424. Browser 424 may be utilized to, e.g., view or otherwise access web documents from the Internet, for example. A browser, such as 424, may comprise a standalone application, or an application that is embedded in or forms at least part of another program or operating system, etc. Resources 406 may also include or present a graphical user interface, such as 426. An interface, such as 426, may include, for example, an electronic display screen or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples.

In an example embodiment, a user may submit a market value estimate to system 402 via resources 406, for example. Via interface 426, for example, a user may enter a market value estimate, although claimed subject matter is not limited in scope in this respect. Signals representing a market value estimate may be transmitted via resources 406 to system 402 via communications network 404, for example. Likewise, system 402 may generate a ranking or an appraisal.

In an example embodiment, system 402 may generate an appraisal for a unique identifiable object, such as a parcel of real estate. System 402 may also make the appraisal available electronically via a network, which may, in essence, market the appraisal to prospective purchasers. For example, availability of an appraisal for sale that corresponds to an identifiable object may be made public via the web. For someone interested in acquiring an appraisal that corresponds to an identifiable object, system 402 may send (e.g., physically mail, electronically transmit, etc.) an appraisal that corresponds to an identifiable object in exchange for suitable financial remuneration, such as a monetary payment, for example, or adequate proof of capability to make such payment, such as via a third party, for example. A variety of approaches are possible and claimed subject matter is intended to cover such approaches.

In certain example embodiments, a ranking or appraisal may be produced using a prediction market e.g., valuation of a unique object, such as real estate, for example, may be established with fictional currency. Prediction markets may be used as an intermediary, at least partially, to obtain measurements of accuracy so that ranking, for example, may be employed, such as based at least partly on a history of forecasts, for example. In an example embodiment, a participant in a prediction market, for example, may use fictional or virtual currency to place one or more bets on any of multiple types of events, such as pertaining to valuation of one or more unique objects, such as, for example, real estate. Examples may include, but are not limited to, betting on a range of prices at which an object will sell, betting on how long an object will take to sell, betting on whether an object will sell, or any combination thereof, etc. As participants, in effect, place bets and events come to pass, fictional currency may be gained or lost. Amounts of fictional currency that participants have earned may correspond to accuracy of prediction since currency is earned if predictions are correct. Thus, a measurement of accuracy may be related to earnings in this particular situation, although in other situations earnings may not necessarily provide a measurement of accuracy, such as if trading securities, for example. In this latter situation, one may have earnings although predictions may not necessarily be accurate. Thus, earnings may be employed to generate a ranking. Other characteristics of individuals that are available may also be used to generate a ranking, such as previously described in alternate embodiments.

In an example embodiment, one or more sources, such as real estate agents, may use fictional currency to place one or more bets on any of multiple types of events, as described above, such as pertaining to real estate. Amounts of fictional currency that sources have earned on various bets may, therefore, be used to generate a ranking. For example, fictional currency earned may reflect transaction value and estimate of market value, similar to the approach described previously, although here a prediction market provides an intermediary mechanism that may be employed. Other characteristics of sources that are available, such as e.g. measures of experience or a number of transactions, may also be used to generate a ranking.

In an example embodiment, a prediction market for one or more unique objects, which may be subject to a transaction in the physical or real world, may be established with fictional or virtual currency. In an example embodiment, sources of estimates of market value may generate estimates of market value to be used in conjunction with a prediction market. These estimates may be employed, for example, in an artificial trading market in which virtual currency is employed. Earnings may reflect accuracy of estimates if, for example, trading takes place around a prediction of sale price, for example. Thus, a ranking of sources may be generated based, at least in part, on respective amounts of virtual currency that are accumulated by respective sources, wherein the virtual currency is traded in an artificial online trading market. Likewise, embodiments may employ prediction markets in conjunction with other approaches, such as described previously.

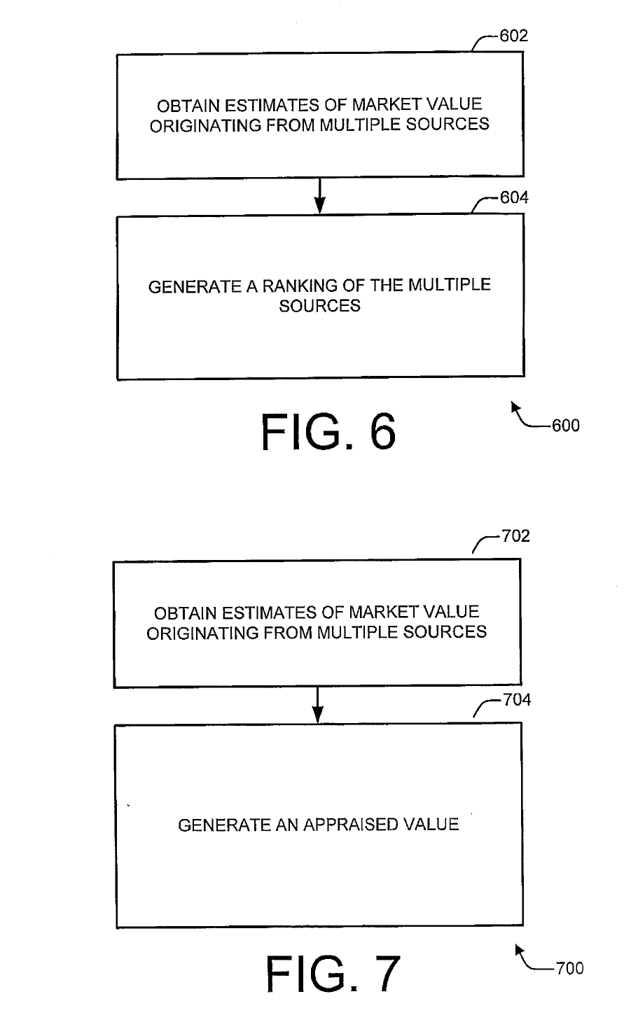

FIG. 6 is a flow diagram 600 that illustrates an embodiment of an example method for generating a ranking based, at least in part, on estimates of market value. As illustrated, flow diagram 600 may include any of operational blocks 602-604. Although operations 602-604 are shown and described in a particular order, it should be understood that methods may be performed in alternative manners without departing from claimed subject matter, including but not limited to with a different order or number of operations. Also, at least some operations of flow diagram 600 may be performed so as to be fully or partially overlapping with other operation(s).

For certain example embodiments, one or more of operations 602-604 may be performed at least partially by a computing platform or device. At operation 602, estimates of market value of one or more unique objects may be obtained, with the estimates of market value originating from multiple sources. At operation 604, a ranking of the multiple sources may be generated based, at least in part, on one or more indications of accuracy of the estimates of market value relative to transaction value that corresponds to the one or more objects. However, claimed subject matter is not limited to these particular example embodiments for generating a ranking of sources. In another example embodiment, illustrated by FIG. 7, estimates of market value of one or more objects may be obtained from multiple sources, denoted by operation 702. An appraised value may be generated based, at least in part, on the estimates of market value and based, at least in part, on one or more indications of accuracy of estimates of market value relative to transaction value that corresponds to the one or more objects, denoted by operation 704. However, claimed subject matter is not limited to these particular example embodiments for generating an appraisal value for an object.

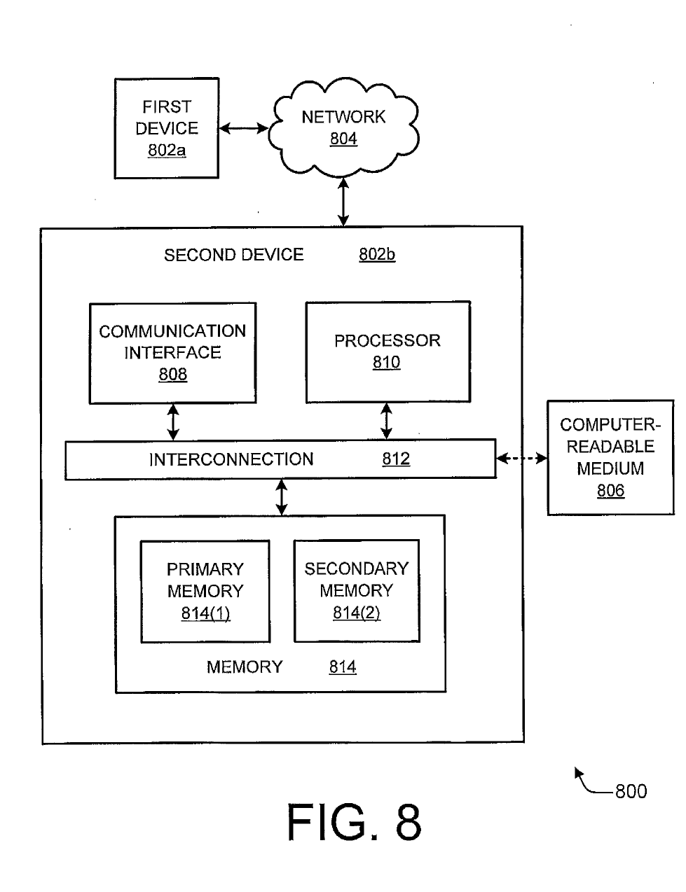

FIG. 8 is a schematic block diagram 800 of example devices, according to an embodiment, that may implement one or more aspects of using estimates of market value as one or more computing platforms. As illustrated, block diagram 800 may include a first device 802a or a second device 802b, which may be operatively coupled together via one or more networks 804. A device 802 may comprise, correspond to, implement, or realize a ranking or appraisal system 402, or user resources 406 (e.g., both of FIG. 4), etc. Network 804 may correspond to communications network 404 (e.g., of FIG. 4).

For certain example embodiments, first device 802a may be adapted to receive input commands, such as estimates of market value, from a user or provide output rankings or appraisals to a user. Network 804, as shown in FIG. 8, is representative of one or more communication links, processes, or resources capable of supporting an exchange of signals between first device 802a and second device 802b. Second device 802b may be adapted to generate rankings of sources or appraisals of value of objects.

As illustrated, but by way of example only, second device 802b may include at least one communication interface 808, one or more processors 810, at least one interconnection 812, or at least one memory 814. Memory 814 may include at least a primary memory 814(1) or a secondary memory 814(2). Second device 802b may have access to at least one computer-readable medium 806. Although not explicitly shown, first device 802a may also include any components illustrated with regard to second device 802b.

By way of an example embodiment but not limitation, second device 802b may include at least one processor 810 that is operatively coupled to memory 814 via interconnection 812. Memory 814 may comprise any data storage mechanism. Although not explicitly shown in FIG. 8, memory 814 may store or include instructions. Instructions stored in memory 814 may be executable by processor 810 to perform, for example, at least a portion of one or more procedures, methods, or any combination thereof, etc. that are described herein. Although illustrated in this example as being separate from processor 810, it should be understood that at least a part of memory 814 may be provided within or otherwise co-located with or coupled directly to processor 810.

As shown, second device 802b may be coupled to or have access to computer-readable medium 806. A computer-readable medium may include, for example, any medium that can store, carry, or make accessible data, code, or instructions for execution by one or more devices in block diagram 800. Additionally or alternatively, a computer-readable medium 806 may comprise at least a portion of memory 814.

According to embodiments that include at least one memory, one or more portions of memory 814 may store signals representative of data or information as expressed by a particular state of memory 814. For example, an electronic signal representative of data or information may be “stored” in a portion of a memory device by affecting or changing a state of such portions of memory 814 to represent data or information as binary information (e.g., ones and zeros). As such, in a particular implementation, a change of state of a portion of memory to store a digital signal representative of data or information may constitute a transformation of memory 814 to a different state or thing.

Second device 802b may also include, for example, communication interface 808 that provides for or otherwise supports an operative coupling of second device 802b to at least network 804. By way of example but not limitation, communication interface 808 may include a network interface device or card, a modem, a router, a switch, a transceiver, or any combinations thereof, etc., just to name a few examples. Electrical digital signal(s) (not shown) may be manipulated by second device 802b. By way of example but not limitation, electrical digital signals may be received from or transmitted onto network 804 using communication interface 808. Additionally or alternatively, electrical digital signals may be stored to or read from memory 814 using interconnection 812.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although claimed subject matter is not limited in scope in this respect, one embodiment may comprise one or more articles, such as a storage medium or storage media, for example, that may have stored thereon instructions executable by a specific or special purpose system or apparatus. As one potential example, a specific or special purpose computing platform may include one or more processing units or processors; one or more input/output devices, such as a display, a keyboard or a mouse; or one or more memories, such as static random access memory, dynamic random access memory, flash memory, or a hard drive; although, again, claimed subject matter is not limited in scope to this example.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” “generating,” “ranking,” “obtaining,” “ascertaining,” “comparing,” “transmitting,” “receiving,” “normalizing,” “providing,” “initiating transmission,” “exchanging,” “selling,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an example embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

In the preceding description, various aspects of claimed subject matter have been described. For purposes of explanation, systems or configurations were set forth to provide an understanding of claimed subject matter. However, claimed subject matter may be practiced without those specific details. In other instances, well-known features were omitted or simplified so as not to obscure claimed subject matter. While certain features have been illustrated or described herein, many modifications, substitutions, changes, or equivalents will now occur to those skilled in the art. It is, therefore, to be understood that the appended claims are intended to cover all such modifications or changes as fall within the true spirit of claimed subject matter.

1. A method comprising: generating, via a computing platform, electrical signals that represent one or more metrics of accuracy of estimates of market value of a plurality of unique objects, said estimates of market value having originated from multiple sources, and generating electrical signals that represent a ranking of said multiple sources based, at least in part, on said electrical signals that represent one or more metrics, said generating comprising generating normalized ranking across said multiple sources and across said plurality of unique objects.

2. (canceled)

3. The method of claim 1, wherein said generating a normalized ranking further comprises: scoring estimates of market value such that a given source is able to lose one or more points to other sources or gain one or more points from said other sources based at least in part on accuracy of the respective market estimates.

4. The method of claim 1, wherein said generating a normalized ranking further comprises: scoring k estimates of market value such that k+1−2 m points are assigned to an mth most accurate estimate of market value, where k and m comprise whole numerals.

5. The method of claim 4, wherein said generating a normalized ranking further comprises: aggregating point scores across said plurality of unique objects for respective sources of said multiple sources.

6. The method of claim 5, wherein said aggregating point scores across said plurality of unique objects for respective sources of said multiple sources comprises aggregating point scores by type of object.

7. The method of claim 1, further comprising: receiving signals representing a request that relates to valuation of said plurality of unique objects; and initiating transmission of signals that represent said ranking.

8. The method of claim 1, wherein said generating said ranking comprises: generating said ranking based, at least partly, on respective experience of said multiple sources.

9. The method of claim 1, wherein said generating further includes generating an appraised value for said plurality of unique objects based, at least partly, on said estimates of market value from the multiple sources and based, at least partly, on said one or more metrics.

10. The method of claim 9, and further comprising: electronically providing said appraised value in exchange for value.

11. The method of claim 1, wherein said generating further includes generating an appraised value for said plurality of unique objects based, at least partly, on said estimates of market value from said multiple sources and based, at least partly, on said ranking.

12. The method of claim 11, and further comprising: electronically providing said appraised value in exchange for value.

13. The method of claim 1, wherein said estimates originated from said multiple sources are provided in exchange, at least in part, for an opportunity to participate in said ranking.

14. The method of claim 1, wherein said generating comprises generating said ranking based, at least in part, on amounts of virtual currency accumulated by said multiple sources, wherein said virtual currency is traded via an artificial online trading market.

15. The method of claim 14, wherein said artificial online trading market comprises a prediction market.

16. A method comprising: receiving, via a computing platform, one or more electrical signal that represent metrics of accuracy of estimates of market value of a plurality of unique objects, said estimates of market value having originated from multiple sources, and generating electrical signals that represent a ranking of said multiple sources based, at least in part, on said one or more electrical signal that represent metrics, said generating comprising generating a normalized ranking across said multiple sources and across said plurality of unique objects.

17. (canceled)

18. The method of claim 16, wherein said receiving further includes receiving an appraised value for said plurality of unique objects based, at least partly, on said estimates of market value from said multiple sources and based, at least partly, on said one or more metrics.

19. An apparatus comprising: a computing platform; said computing platform to generate one or more metrics of accuracy of estimates of market value of a plurality of unique objects, said estimates of market value having originated from multiple sources, and a ranking of said multiple sources based, at least in part, on said one or more metrics.

20. (canceled)

21. The apparatus of claim 19, wherein said computing platform to further generate an appraised value for said plurality of unique objects based, at least partly, on said estimates of market value from said multiple sources and based, at least partly, on said one or more metrics.

22. The apparatus of claim 19, wherein said computing platform to further generate an appraised value for said plurality of unique objects based, at least partly, on said estimates of market value from said multiple sources and based, at least partly, on said ranking.
